(19) United States
(12) Patent Application Publication
(10) Pub. No.: US 2025/0189045 A1
(43) Pub. Date: Jun. 12, 2025

(54) CLAMPED DIAPHRAGM VALVE ASSEMBLY

(71) Applicant: IRR Manufacturing Enterprises, LLC, Stamford, CT (US)

(72) Inventors: Chong Hun YI, Mechanicsburg, PA (US); James Richard DANIELS, Lititz, PA (US); Thomas Joseph STECKBECK, York, PA (US); Richard KOVACS, Lancaster, PA (US)

(73) Assignee: ITT Manufacturing Enterprises, LLC, Stamford, CT (US)

(21) Appl. No.: 18/909,170

(22) Filed: Oct. 8, 2024

Related U.S. Application Data
(60) Provisional application No. 63/608,511, filed on Dec. 11, 2023.

(51) Int. Cl. F16K 7/12; F16K 27/02

(52) U.S. Cl. CPC F16K 7/126; F16K 27/0236

(57) ABSTRACT

A diaphragm valve assembly includes a bonnet portion and a body portion affixed together through a clamp structure providing pressure to a perimeter seal through angled inside surface of the clamp and matching angled surfaces of the bonnet and body portions. While the clamp provides load on the perimeter seal, a second level of sealing may be accomplished through an O-ring seal between the bonnet portion and the body portion. An adapter structure may be used to affix conventional bonnet and body portions through a clamp. The adapter structure may be implemented in various forms. A weir of the body portion and a bead of the bonnet portion may be aligned through fold-over or extended tabs of the diaphragm and cushion.

### CROSS-REFERENCE TO RELATED APPLICATIONS

This application claims priority to U.S. Provisional Patent Application Ser. No. 63/608,511 filed on Dec. 11, 2023. The disclosures of the Provisional Application are hereby incorporated by reference in their entirety.

### BACKGROUND

Unless otherwise indicated herein, the materials described in this section are not prior art to the claims in this application and are not admitted as prior art by inclusion in this section.

Diaphragm valves (or membrane valves) include a valve body with two or more ports, a diaphragm, and a weir or seat upon which the diaphragm seals closing the valve. A perimeter seal of the diaphragm seals the valve assembly to prevent external leakage. Diaphragm valves operate by a linear motion applied to a diaphragm to force the diaphragm against a sealing surface in a mating valve body to stop and seal flow and close the valve. To open the valve and allow flow, the diaphragm is retracted away from the sealing surface. Diaphragm valves may be operated by a variety of methods, such as electrically, pneumatically, and manually.

### SUMMARY

The present disclosure generally describes a diaphragm valve assembly, where a bonnet portion and a body portion are affixed together through a clamp structure providing pressure to a perimeter seal through angled inside surface of the clamp and matching angled surfaces of the bonnet and body portions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a perspective view of three diaphragm valve assemblies with clamps coupled in series;

FIGS. 2A and 2B illustrate perspective and cross-section views of a pneumatically actuated diaphragm valve assembly with a clamp;

FIGS. 3A and 3B illustrate assembly and assembled perspective and cross-section views of a pneumatically actuated diaphragm valve assembly with a clamp providing two levels of sealing between the bonnet portion and the body portion;

FIG. 3C illustrates manufacturing of the body part of a diaphragm valve assembly through forging and machining;

FIG. 4 illustrates clearances in a dual diaphragm valve assembly with clamps;

FIG. 5 illustrates cross-section views of a conventional pneumatically actuated diaphragm valve assembly and a pneumatically actuated diaphragm valve assembly according to examples for comparison purposes;

FIG. 6 illustrates a comparison of a conventional manually actuated diaphragm valve assembly and a manually actuated diaphragm valve assembly according to examples in perspective and cross-section views;

FIG. 7 illustrates how the clamp structure can be applied to different sizes of diaphragm valve assemblies;

FIG. 8A through 8C illustrate an adapter structure that may be used to affix a bonnet portion of a diaphragm valve assembly to a conventional to a body portion using the clamp structure;

FIGS. 9A and 9B illustrate another adapter structure that may be used to affix a bonnet portion of a diaphragm valve assembly to a conventional to a body portion using the clamp structure;

FIG. 10 illustrates perspective and cross-section views of a diaphragm valve assembly with an adapter structure, where the bonnet portion and the body portion are affixed using the clamp structure;

FIG. 11 illustrates various views of alignment of a weir and a bead of a diaphragm valve assembly with an adapter structure and a clamp structure;

FIG. 12 illustrates various views of another alignment approach of a weir and a bead of a diaphragm valve assembly with an adapter structure and a clamp structure;

FIG. 13 illustrates a perspective view of a clamp structure; and

FIG. 14 illustrates various dimensions in a portion of a diaphragm valve assembly with the clamp structure,

some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and/or devices associated with a diaphragm valve assembly, where a bonnet portion and a body portion are affixed together through a clamp structure.

Briefly stated, diaphragm valve assemblies are described, where a bonnet portion and a body portion are affixed together through a clamp structure providing pressure to a perimeter seal through angled inside surface of the clamp and matching angled surfaces of the bonnet and body portions. While the clamp provides load on the perimeter seal, a second level of sealing may be accomplished through an O-ring seal between the bonnet portion and the body portion. In some examples, an adapter structure may be used to affix conventional bonnet and body portions through a clamp. The adapter structure may be implemented in various forms. A weir of the body portion and a bead of the bonnet portion may be aligned through fold-over or extended tabs of the diaphragm and cushion.

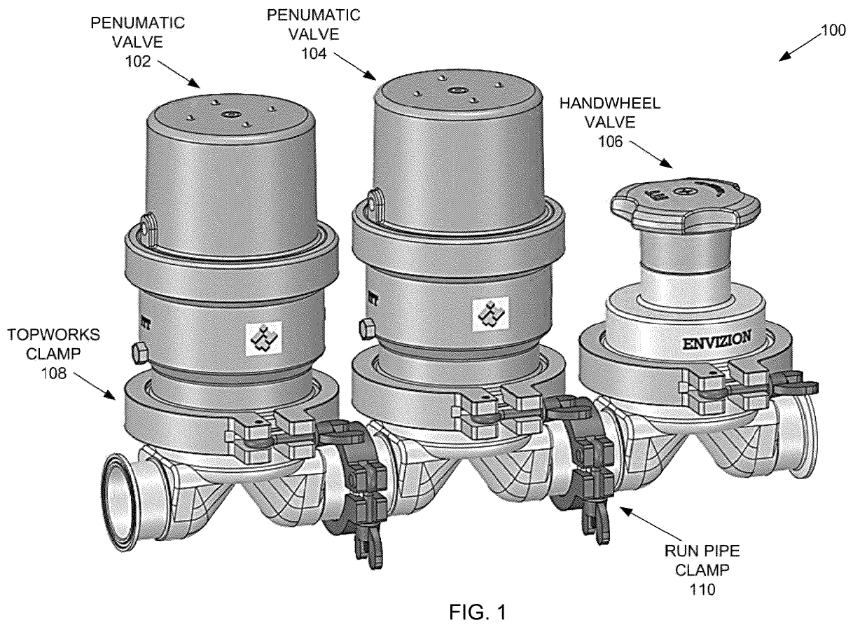

FIG. 1 illustrates a perspective view of three diaphragm valve assemblies with clamps coupled in series, arranged in accordance with at least some embodiments described herein.

Diaphragm valve assemblies include a valve body portion with two or more ports, a diaphragm, and a weir or seat upon which the diaphragm seals closing the valve. A perimeter seal of the diaphragm seals the valve assembly to prevent external leakage by application of pressure from the bonnet portion. In conventional diaphragm valve assemblies, the bonnet portion and the body portion are typically affixed together through nuts and bolts or screws. However, multiple parts (bolts, nuts, screws, etc.) may increase risk of failure (e.g., leakage) through failure of one of those parts (e.g., rust or mechanical failure). Furthermore, uneven adjustment of the parts may also result in leakage by failing to provide even load to the perimeter seal around the perimeter.

In some examples, a clamp structure may provide even load to the perimeter seal by bringing the bonnet portion and the body portion through angled inside surface of the clamp and angled matching surfaces of the bonnet portion and the body portion. The clamp structure may not only be easy to apply (e.g., through a single mechanism, but may also fit into dimensions of conventional diaphragm valve assemblies.

In some implementations, diaphragm valve assemblies may be used in series and may be actuated through different means such as manual, pneumatic, or electrical actuation. Diagram 100 shows an example configuration of three diaphragm valve assemblies in series. First two diaphragm valve assemblies include pneumatic valves 102 and 104, while the third diaphragm valve assembly include a handwheel valve 106 (manual). The diaphragm valve assemblies are coupled together (body portions) through run-pipe clamps 110, where each of the diaphragm valve assemblies includes a topworks clamp to affix the bonnet portions with respective body portions. The example configurations described herein are compatible to all existing integrated block valves.

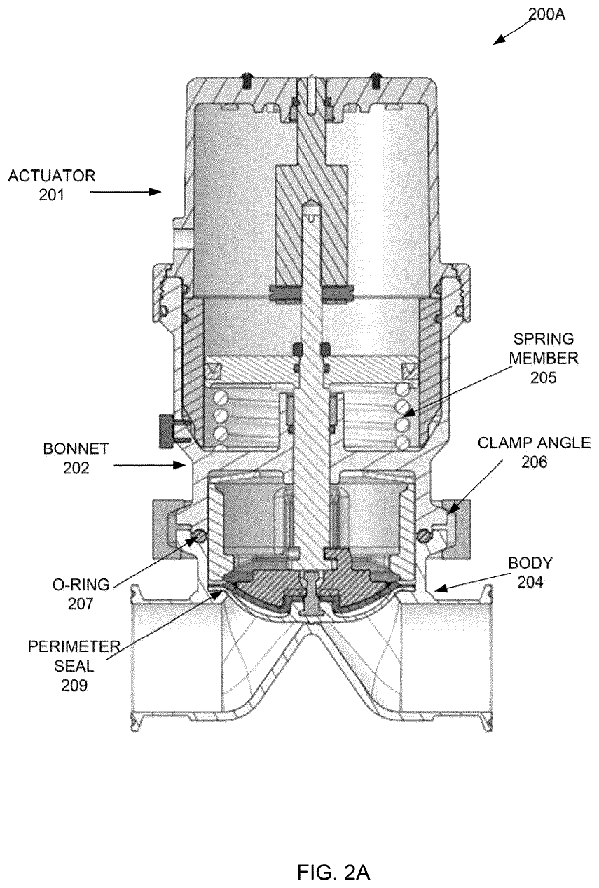

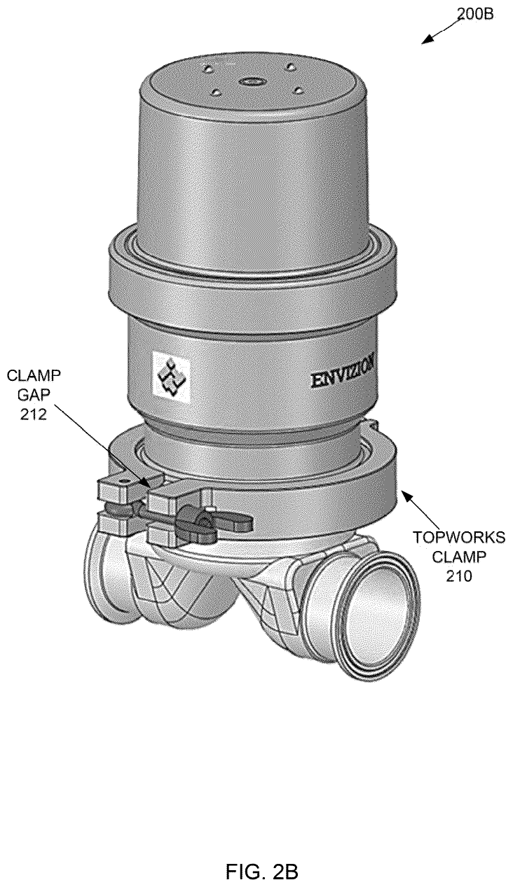

FIGS. 2A and 2B illustrate perspective and cross-section views of a pneumatically actuated diaphragm valve assembly with clamp, arranged in accordance with at least some embodiments described herein.

In the cross-section view of the pneumatically actuated diaphragm valve assembly in diagram 200A, actuator 201, bonnet 202, body 204, and clamp angle 206 are identified. The diaphragm valve assembly may also include a backing, cushion, and a diaphragm assembly. The body 204 may include an inner wall, a first portion of which may define a first one of the valve ports and a second portion of the inner wall may define a second one of the valve ports. In some examples, the valve ports may be designated as ingress and egress ports. The inner wall of the body 204 and the valve ports may define a controllable flow path that extends along the inner wall between the first one of the valve ports and the second one of the valve ports. Flow of liquids or gases through the controllable flow path may be controlled by the diaphragm assembly, which may provide peripheral seal as well as weir cross-section seal to restrict the flow.

The clamp structure 108 may include two or more portions of the clamp, one or more hinges, and a safety mechanism comprising a nut-bolt combination or similar. For example, a wing nut may be used for manual or tool-assisted fastening of the clamp. In other examples, a hex nut, a safety nut, or similar components may also be used. An inside surface of the clamp may include angled upper and lower portions, which may come in contact with similarly angled matching outside surfaces of the actuator portion (bonnet) and body portion of the diaphragm valve assembly. Thus, when the clamp is fastened, the matching angled surfaces may press the bonnet onto the body portion providing an even load to the perimeter seal 209, and thereby, providing strong and durable seal against external leakage. As discussed further below, an O-ring seal 207 placed between the bonnet and the body portion may provide a secondary level of sealing.

Diagram 200B in FIG. 2B shows a perspective outside view of the same diaphragm valve assembly with the clamp gap 212 which may be adjusted depending on the desired pressure on the seal(s). In some examples, the clamp affixed diaphragm valve allows for deflection of a spring member 205 (e.g., a Belleville washer) to obtain correct pressures on the perimeter seal.

Example embodiments are shown and discussed with specific components and configurations, which are not to be interpreted as limitations on embodiments. For example, various example valve assemblies are shown with a handwheel actuator or a pneumatic actuator. Other forms of actuation may include an electric motor or even hydraulic actuation. Similarly, other parts may be replaced or configured differently depending on implementation specifications using the principles discussed herein.

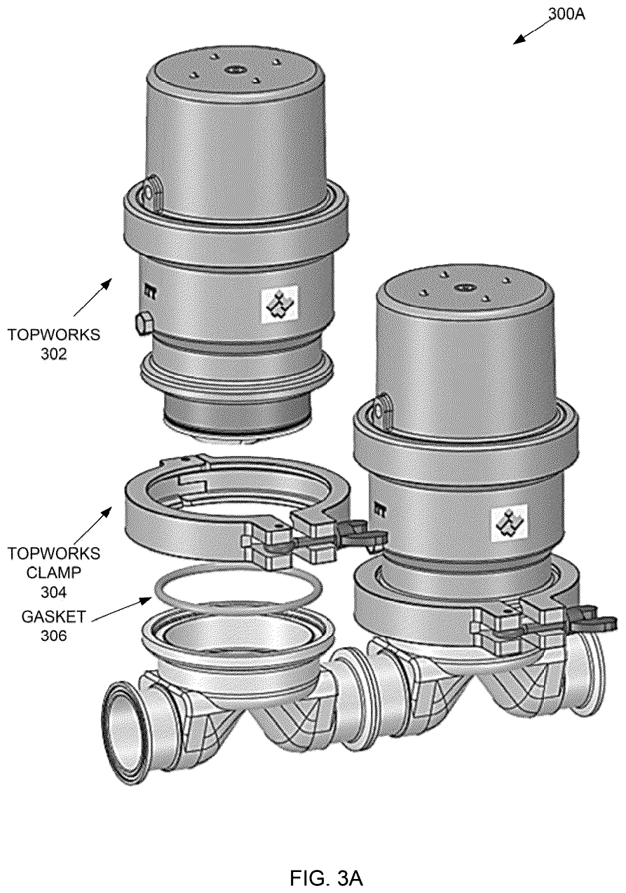

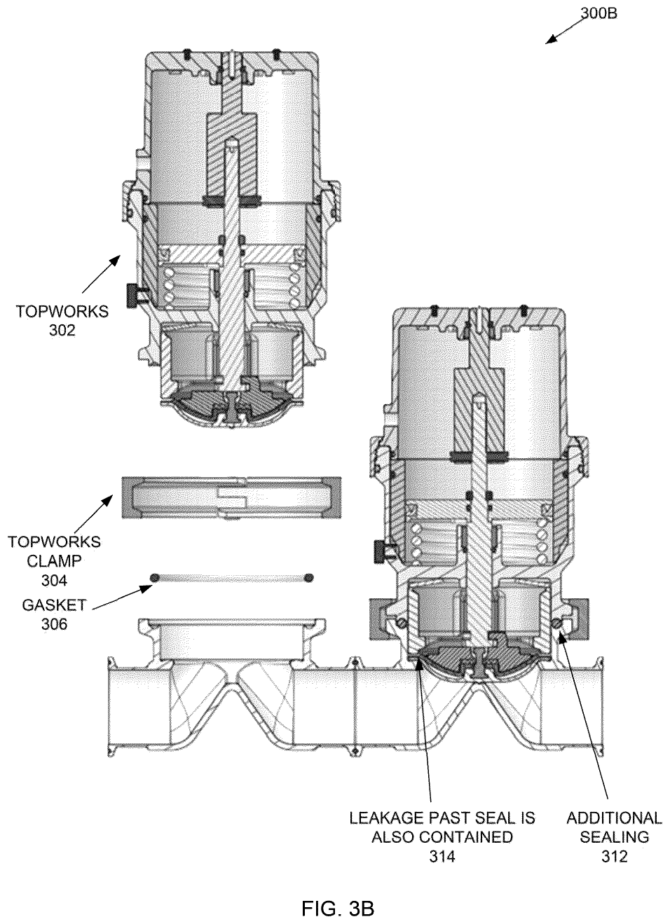

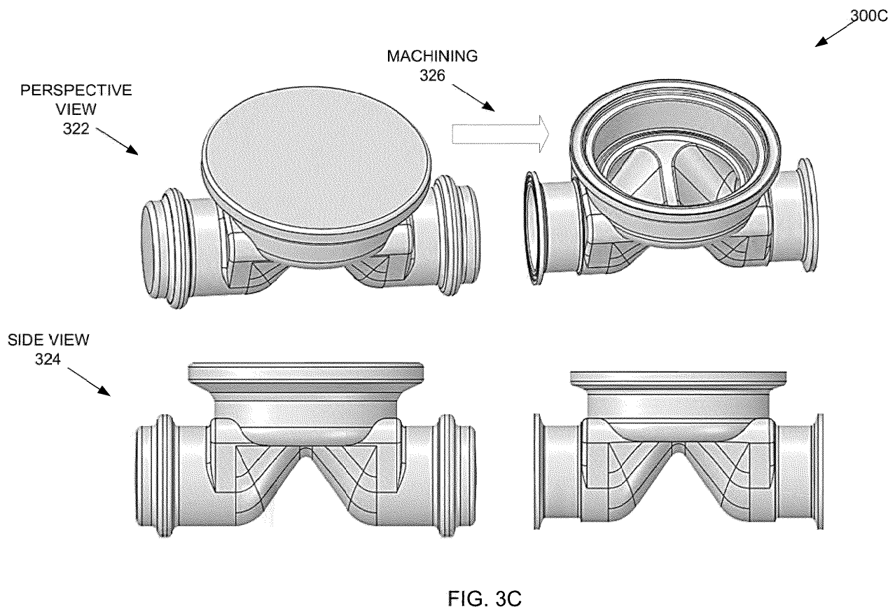

FIGS. 3A and 3B illustrate assembly and assembled perspective and cross-section views of a pneumatically actuated diaphragm valve assembly with clamp providing two levels of sealing between the bonnet portion and the body portion, arranged in accordance with at least some embodiments described herein.

Diagram 300A shows a two valve combination, where the topworks 302 (actuator portion and bonnet portion) of each valve is affixed to the respective body portions through topworks clamps 304. Gasket 306 is the O-ring secondary seal placed between the bonnet and body of each diaphragm valve.

In a diaphragm valve, the bonnet houses a spindle, which through a movement of a pneumatic actuator, and electric motor, or a handwheel is pressed down onto the compressor. The compressor, in turn, presses down a center portion of the diaphragm assembly (diaphragm boss) for passage sealing. A diaphragm stud may be used to provide mechanical force from the compressor to the center of the diaphragm assembly when pulling up to open the passageway. O-rings may be used to seal an inner wall of the bonnet and an outside surface of the compressor, as well as, an outside wall of the bonnet and an inside surface of the actuator. A bottom portion of the bonnet may press down onto a peripheral surface of the diaphragm assembly allowing sealing of the periphery of the raised portion of the body.

As shown in diagram 300B, peripheral surface of the perimeter seal being pressed by the squeezing action of the clamp 304 may provide sealing against external leakage between the body and the bonnet. Secondary sealing may also be provided by the gasket 306 and the pressure applied by the clamp 304.

FIG. 3C illustrates manufacturing of the body part of a diaphragm valve assembly through forging and machining, arranged in accordance with at least some embodiments described herein.

Diagram 300C shows top perspective view 322 and side view 324 of a body portion of a diaphragm valve during manufacturing process. In some examples, the body portion may be produced through forging. The run pipe openings and the top opening for the bonnet coupling may then be created through machining 326. The body portion may be produced through other means as well using the principles described herein.

In a diaphragm valve, one of the major maintenance items is the diaphragm assembly that may need to be replaced. The diaphragm assembly may be replaced faster and easier in a valve with clamp compared to nuts/bolts or screw assembly configuration. Further, the clamp may include wing-nuts, thus, not require tool-assist to install and remove.

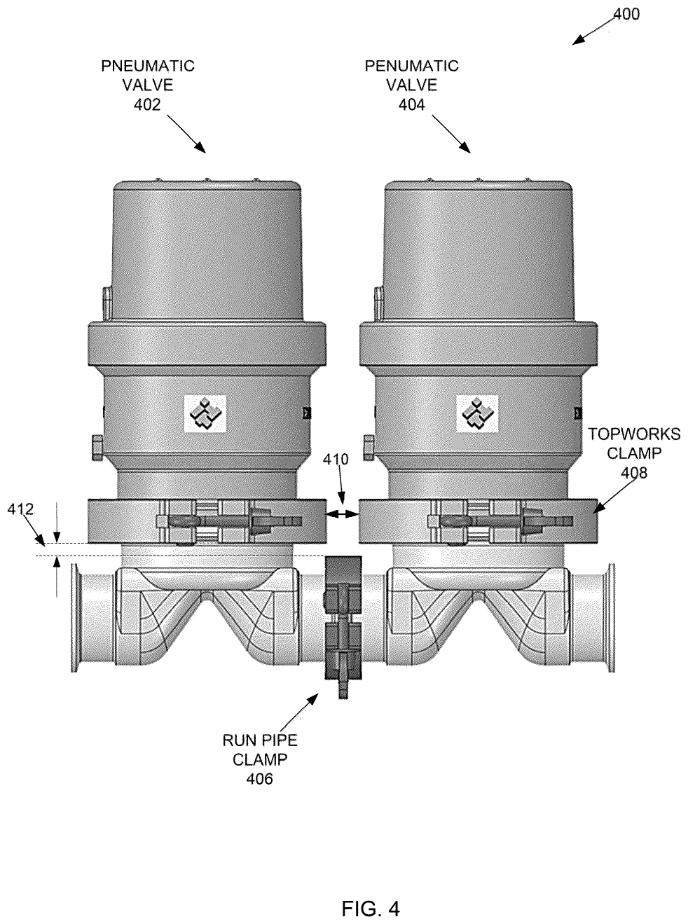

FIG. 4 illustrates clearances in a dual diaphragm valve assembly with clamps, arranged in accordance with at least some embodiments described herein.

Diagram 400 shows pneumatically actuated diaphragm valves 404 and 404 coupled together through run-pipe clamp 406 with each of the valves' bonnets and body portions being coupled together through clamps 408. The clearance 410 between the clamps of the two valves and the clearance 412 between the bottom of the clamp 408 and a top of the run-pipe clamp 406 are shown to indicate spacings in clamp configuration. In one implementation example, the clearance 410 may be 0.74″ and the clearance 412 may be 0.29″. These clearances are similar to clearances in nut/bolt or screw fastening configurations of conventional diaphragm valves.

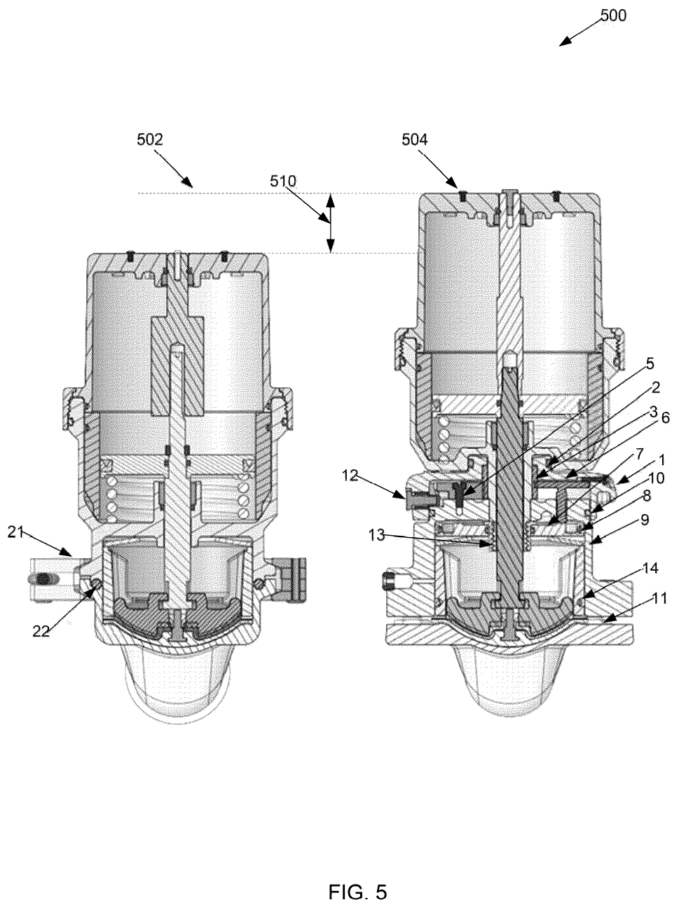

FIG. 5 illustrates cross-section views of a conventional pneumatically actuated diaphragm valve assembly and a pneumatically actuated diaphragm valve assembly according to examples for comparison purposes, arranged in accordance with at least some embodiments described herein.

As shown in diagram 500, a number of components in a conventional diaphragm valve 504 may be eliminated in the clamp diaphragm valve configuration 502, while two components may be added. Through the elimination of components, the clamp pneumatic diaphragm valve may be shorter than conventional diaphragm valve. In some implementation examples, the height difference may be significant.

In some examples, the eliminated components may include, but are not limited to, a bonnet cover, a bonnet cover O-ring, a gear sun, a gear lock, a shoulder screw, three gear planets, a plate load O-ring, a bonnet O-ring, a locking/unlocking button assembly, a threaded collar, and a ring compressor O-ring. The added components are the clamp assembly and the gasket seal (O-ring).

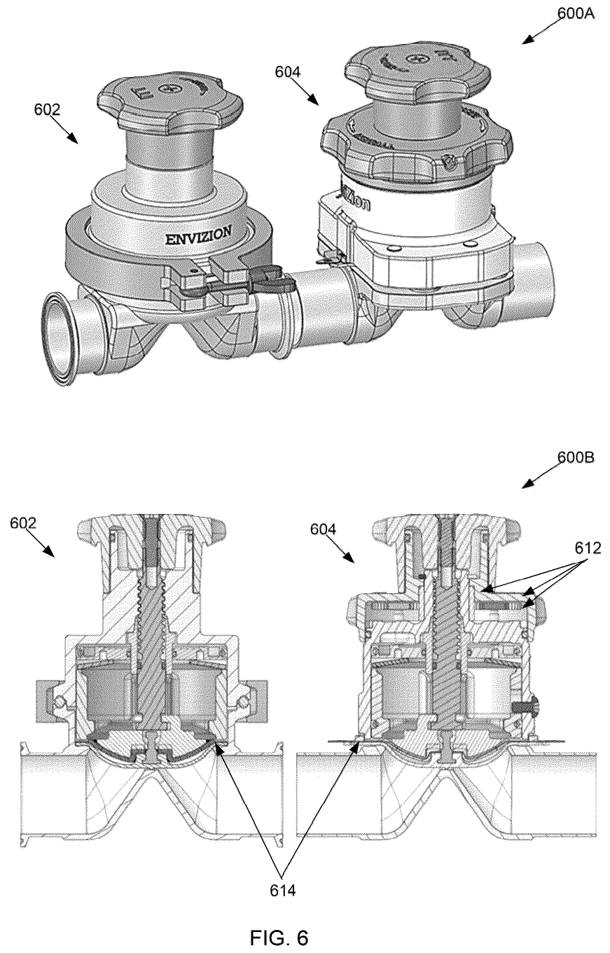

FIG. 6 illustrates a comparison of a conventional manually actuated diaphragm valve assembly and a manually actuated diaphragm valve assembly according to examples in perspective and cross-section views, arranged in accordance with at least some embodiments described herein.

Diagram 600A shows a perspective view manually actuated diaphragm valve with clamp assembly 602 and conventional manually actuated diaphragm valve 604 coupled in series. Same two valves are shown in a cross-section view in diagram 600B. In both configurations, the perimeter sealing 614 is the same. The manually actuated diaphragm valve with clamp assembly 602 further includes the secondary seal provided by the gasket, while components 612 such as bonnet cover and gears in the conventional manually actuated diaphragm valve 604 are eliminated.

As discussed herein, the body portion includes an inner wall, a first portion of which may define a first one of the valve ports and a second portion of the inner wall may define a second one of the valve ports. The inner wall of the body and the valve ports define a controllable flow path that extends along the inner wall between the first one of the valve ports and the second one of the valve ports and includes the center portion with raised body bead for contacting the diaphragm assembly and providing a peripheral seal (through the circumference of the substantially circular center portion) and a weir seal (through the diametric linear portion of the center portion).

The inner wall of the body is shaped such that a liquid or a gas is directed from an ingress port to the egress port through a raised center portion (diaphragm valve), where the diaphragm assembly makes contact (in response to manual actuation through the hand wheel) with the raised portion when pressed down and seals the passage preventing the liquid or gas from passing through. In addition to sealing the passage through the body, the diaphragm assembly is also used to seal a periphery of the center portion preventing leakage from inside of the valve assembly to outside.

The configurations shown herein may provide peripheral sealing thrust throughout life, providing for compensation during mechanical and thermal cycling. Furthermore, the configurations may provide excellent centering and position control of all components including superior control of the body-to-upper portion parts positioning, and provides parallelism between peripheral sealing surfaces of the body flange and pressure ring, including allowable compliance for diaphragm thickness variation from non-parallel top/bottom diaphragm flange surfaces. Surface of the body flange or bead, used for peripheral sealing, may be a highly controlled, flat machined surface. Surfaces of the compressor, used for passage sealing, are highly controlled machined surfaces as well.

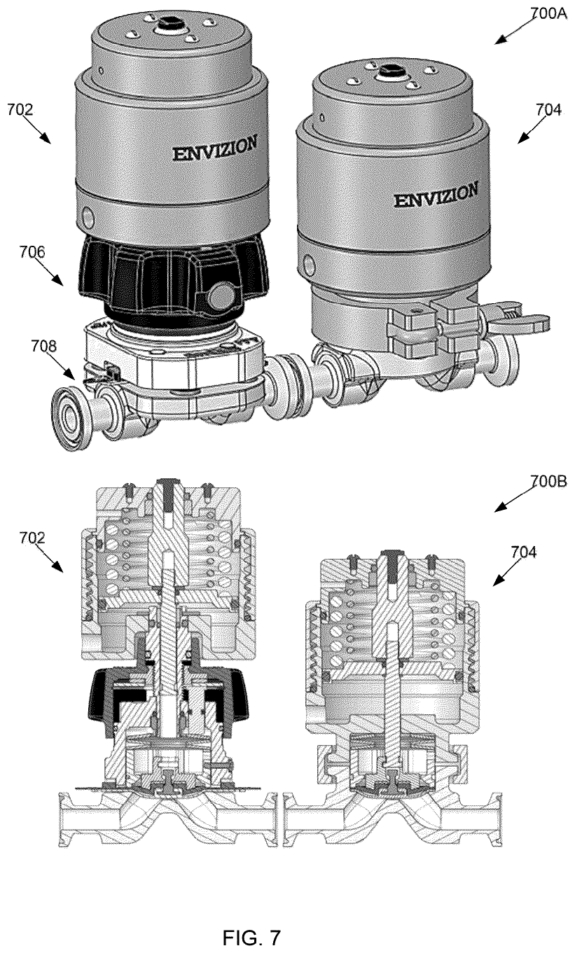

FIG. 7 illustrates how the clamp structure can be applied to different sizes of diaphragm valve assemblies, arranged in accordance with at least some embodiments described herein.

Diagrams 700A and 700B show a perspective and cross-section views of a conventional tall valve and a clamp fastened diaphragm valve according to examples. As shown in the diagrams, the clamp fastened diaphragm valves may replace different sizes of conventional diaphragm valves.

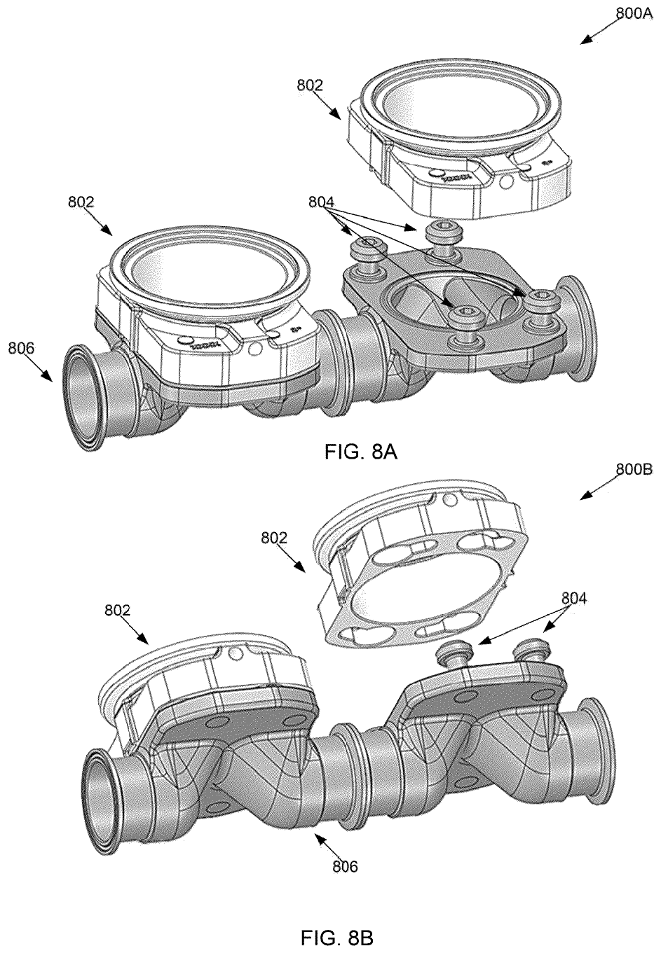

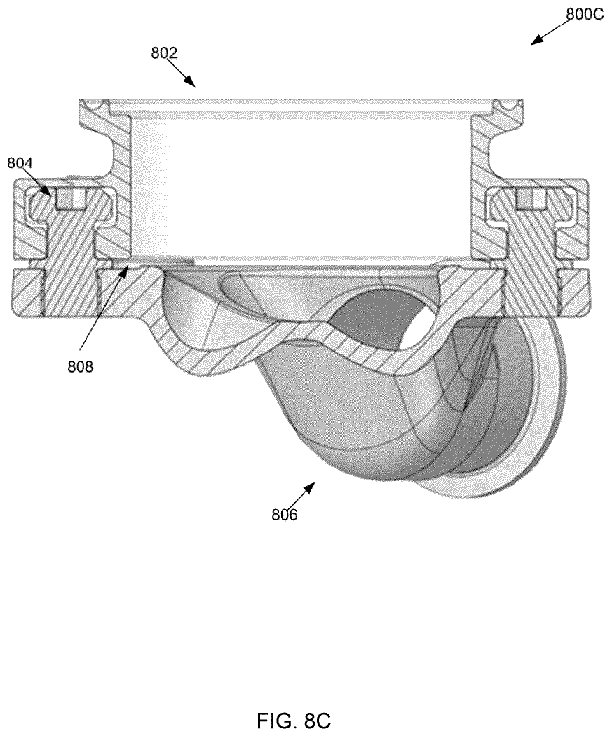

FIG. 8A through 8C illustrate an adapter structure that may be used to affix an actuator portion of a diaphragm valve assembly to a conventional to a body portion using the clamp structure, arranged in accordance with at least some embodiments described herein.

Some examples are directed to applying clamp fastening to existing diaphragm valves (e.g., in the field) through an adapter. Diagrams 800A and 800B show perspective views of body portions 806 of two valves with adapters. Adapter 802 may be fastened onto a top surface (opening) of the body portion through four studs 804 for example. Stud holes in the adapter 802 may fit over the studs and by rotating the adapter 802, it may be affixed to the body portion forming a seal between the two parts. The bonnet of the valve may then be fastened onto the adapter 802 through a clamp assembly (not shown). Without additional sealing, the adapter 802 example in FIGS. 8A and 8B may have minimal height.

Diagram 800C in FIG. 8C shows a cross-section view of the adapter 802 in assembled configuration. A flat seal 808 on a bottom surface of the adapter 802 may provide sealing between the adapter 802 and the body portion 806. Furthermore, the studs 804 may include (integrated or separate) washers that may add to the sealing between the adapter 802 and the body portion 806.

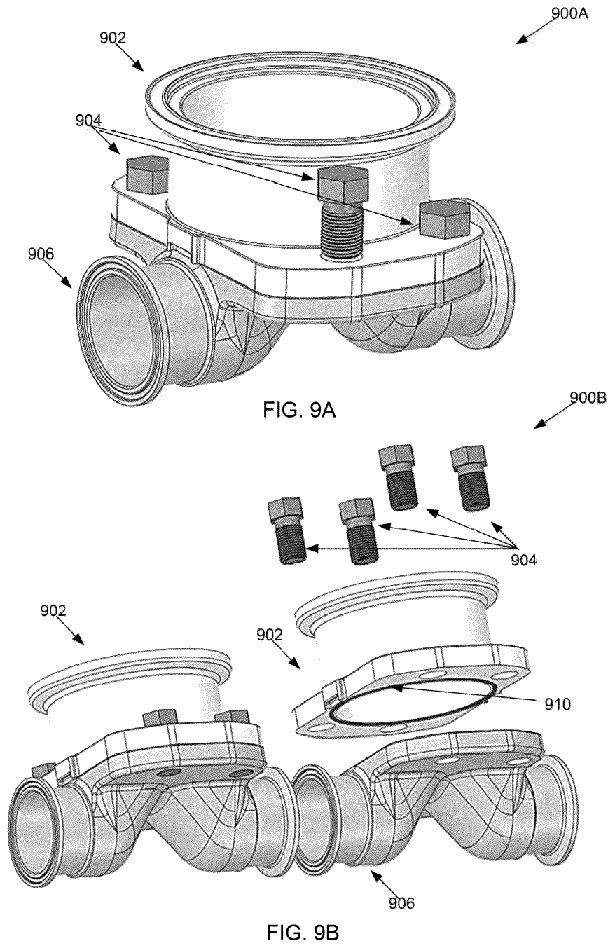

FIGS. 9A and 9B illustrate another adapter structure that may be used to affix an actuator portion of a diaphragm valve assembly to a conventional to a body portion using the clamp structure, arranged in accordance with at least some embodiments described herein.

Diagram 900A shows a different adapter configuration fastened to the body portion 906 through threaded bolts 904. As shown in diagram 900B, an additional O-ring seal 910 may be positioned between the adapter 902 and a top surface of the body portion 906. The O-ring seal 910 may provide an additional level of sealing while adding some height to the adapter (and thereby to the valve).

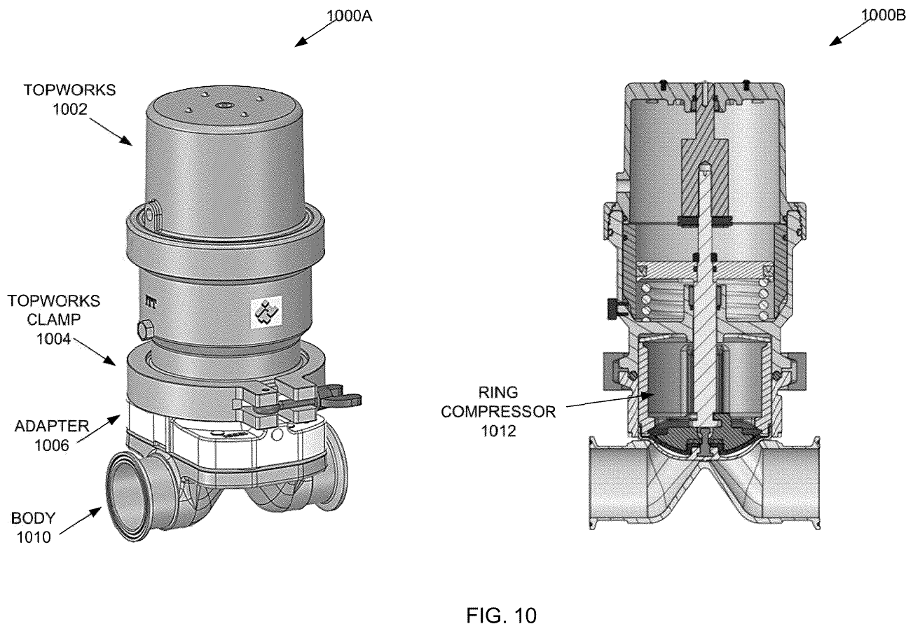

FIG. 10 illustrates perspective and cross-section views of a diaphragm valve assembly with an adapter structure, where the actuator portion and the body portion are affixed using the clamp structure, arranged in accordance with at least some embodiments described herein.

Diagrams 1000A and 1000B show a diaphragm valve assembly (perspective and cross-section views) with an adapter. The valve assembly includes topworks 1002 including the pneumatic actuator and the bonnet portions, body portion 1010, adapter 1006, and clamp assembly 1004. To account for the additional height of the adapter, the ring compressor 1012 may have extended height, but may have the same interface with Belleville washer and diaphragm.

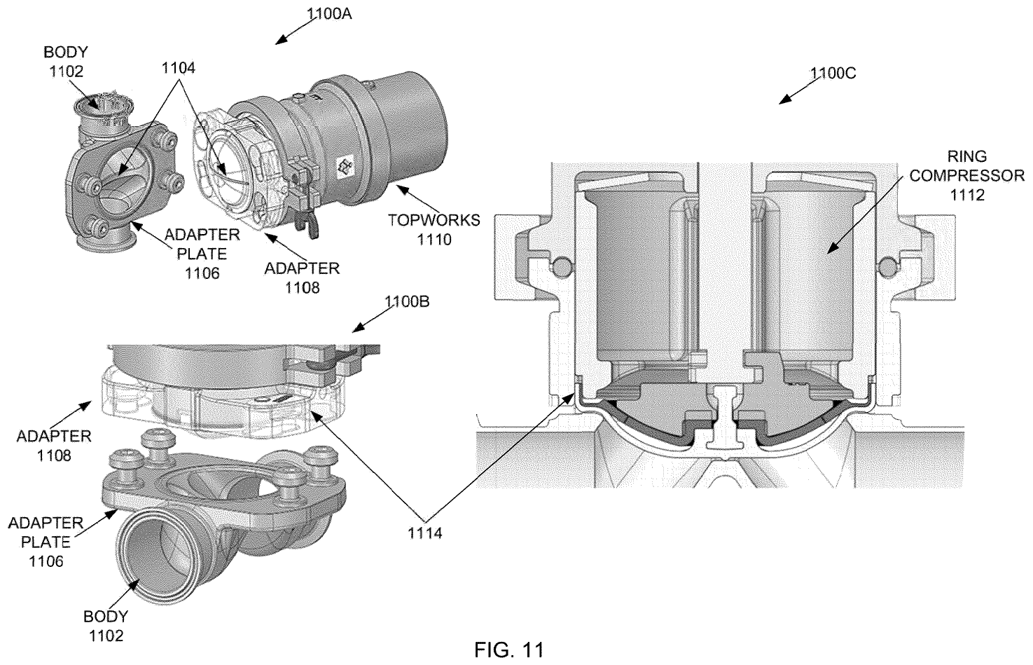

FIG. 11 illustrates various views of alignment of a weir and a bead of a diaphragm valve assembly with an adapter structure and a clamp structure, arranged in accordance with at least some embodiments described herein.

Accurate weir-bead alignment in a diaphragm valve provides for improved sealing when flow is closed. Thus, it is important to ensure the weir and the bead are aligned well when the valve is assembled with an adapter configuration for clamp fastening. Diagram 1100A shows topworks 1110, adapter 1108, and body portion 1102 with an adapter plate 1106, which includes studs for the adapter 1108 to mate with. When the adapter and the adapter plate are mated, the weir and the bead (1104) need to be aligned accurately. In some examples, diaphragm and cushion fold-over tabs 1114 shown in diagrams 1100B and 1100C may align the weir and the bead 1104.

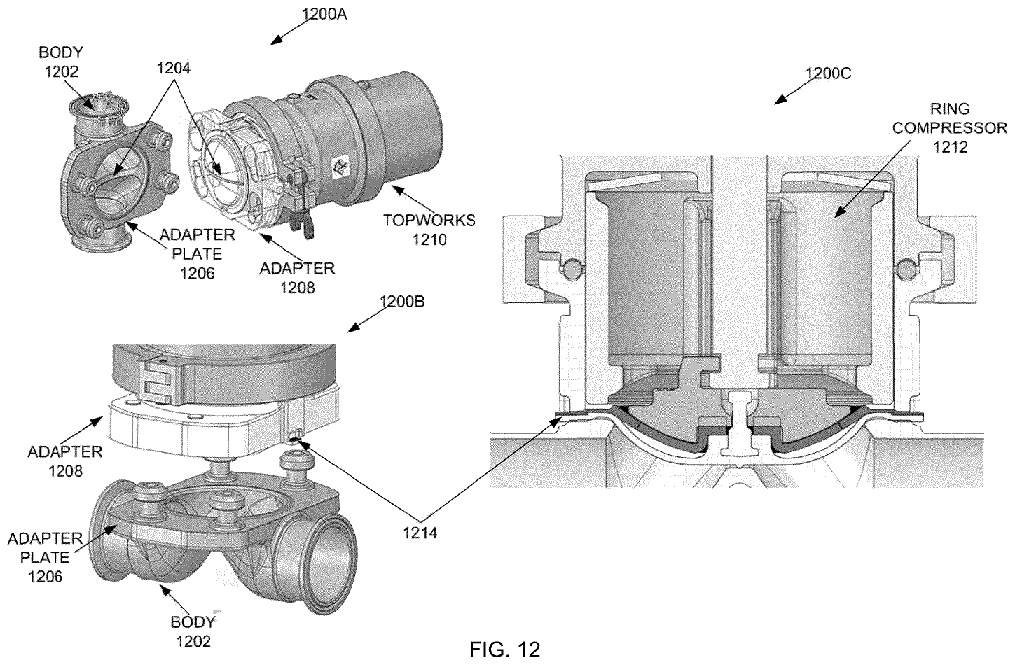

FIG. 12 illustrates various views of another alignment approach of a weir and a bead of a diaphragm valve assembly with an adapter structure and a clamp structure, arranged in accordance with at least some embodiments described herein.

Diagrams 1200A, 1200B, and 1200C show another configuration of weir-bead 1204 alignment in a diaphragm valve with topworks 1210, body portion 1202, adapter 1208, and adapter plate 1206. In the illustrated configuration, extended tabs 1214 on the diaphragm and cushion may assist in aligning the weir and the bead.

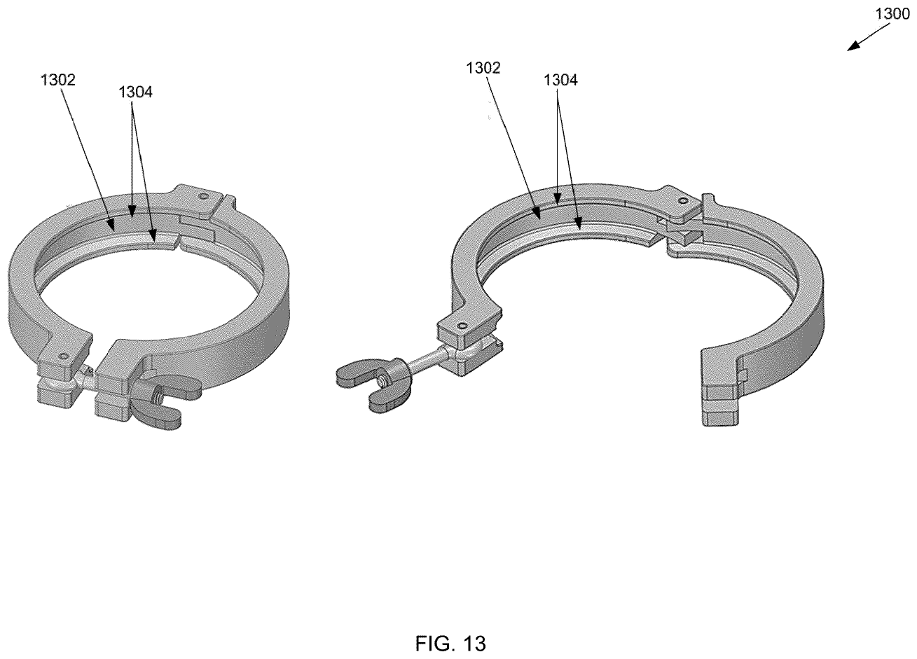

FIG. 13 illustrates a perspective view of a clamp structure, arranged in accordance with at least some embodiments described herein.

Diagram 1300 shows a clamp portion with a sidewall 1302 and top/bottom protrusions 1304. The top/bottom protrusions 1304 provide a grab on opening lips of the bonnet and body portion when they mate (with an O-ring seal in-between). Outside surfaces of the opening lips of the bonnet and body portion may be angled. Similarly, inside surface of the top/bottom protrusions 1304 may have a matching angle. Thus, when the clamp assembly is placed over the mated opening lips of the bonnet and body portion and pressure is applied through the safety mechanism of the clamp assembly, the angled surfaces will force the opening lips of the bonnet and body portion together (also applying pressure on the O-ring seal).

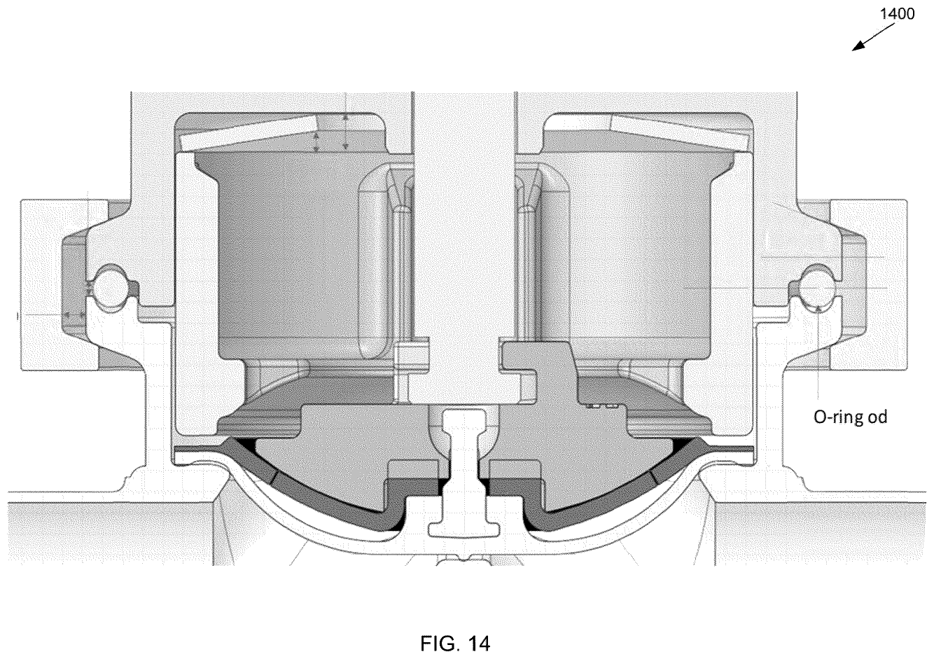

FIG. 14 illustrates various dimensions in a portion of a diaphragm valve assembly with the clamp structure, arranged in accordance with at least some embodiments described herein.

Diagram 1400 shows example dimensions at the interconnect of the bonnet and the body portion. Some of those example dimensions may include 20 degree angle on the surfaces of the clamp assembly (and matching bonnet/body portion lips), 0.220″ O-ring seal diameter, 0.150″ distance between the sidewall of the clamp assembly and an outside surface of the bonnet/body portion, 0.09″ distance between the bonnet lip and the body portion lip. These dimensions are examples for implementation. Other dimensions may be implemented using the principles discussed herein.

As discussed previously, embodiments are not limited to handwheel actuation. Pneumatic (with or without springs) or electric motor, or even hydraulic actuation may also be used in example implementations without departing from the principles described herein.

The benefits of the presently disclosed valve assembly devices are numerous. For example, the valve assemblies with clamp fastening disclosed herein may allow for increased and/or concentrated loading of the peripheral seal, easier replacement of internal components such as diaphragm assembly, etc. Another benefit of example valve assemblies may include simplification of the valve assembly through eliminated components and/or component complexity while adding control with improvement of seal reliability.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A diaphragm valve assembly comprising:
a body portion having an inner wall, a first port defined by a first portion of the inner wall, a second port defined by a second portion of the inner wall, and a controllable flow path defined by a third portion of the inner wall between the first port and the second port;
a diaphragm assembly positioned over an opening along the third portion of the inner wall, the diaphragm assembly configured to provide a peripheral seal along a periphery of the opening and a passage seal along a diametric weir within the opening;
a bonnet to house an assembly comprising a pressure ring, a compressor, and a spindle to actuate a position of the compressor between a closed position and an open position such that the diaphragm assembly forms the passage seal in the closed position or releases the passage seal in the open position;
an actuator to actuate a position of the spindle between the open position and the closed position; and
a clamp assembly to affix the body portion and the bonnet together through application of substantially even pressure by an inside surface of the clamp assembly.

2. The diaphragm valve assembly of claim 1, wherein the actuator is one of a manual actuator, an electrical actuator, and a pneumatic actuator.

3. The diaphragm valve assembly of claim 1, wherein the clamp assembly comprises two or more clamp portions, one or more hinges, and a safety mechanism.

4. The diaphragm valve assembly of claim 3, wherein the safety mechanism comprises a nut-bolt employing a wing nut a hex nut, or a safety nut.

5. The diaphragm valve assembly of claim 3, wherein an inside surface of the two or more clamp portions includes an angled top portion and an angled bottom portion to slidably mate with matching angled outside surfaces of the bonnet and the body portion.

6. The diaphragm valve assembly of claim 1, wherein the assembly in the bonnet further comprises a spring member.

7. The diaphragm valve assembly of claim 1, wherein
the pressure ring is in contact with a peripheral surface of the diaphragm assembly configured to provide a pressure load to the diaphragm assembly to provide the peripheral seal;
a substantially ring-shaped elastic reduced backing cushion is configured to be fitted over the diaphragm assembly within the pressure ring; and
the compressor is within the pressure ring and in partial contact with the reduced backing cushion, the compressor configured to selectively engage a center portion of the diaphragm assembly effective to form the passage seal.

8. The diaphragm valve assembly of claim 1, further comprising:
a diaphragm stud mechanically coupled to the compressor and inserted into a center portion of the diaphragm assembly in order to engage the diaphragm assembly when releasing the passage seal based on a reverse thrust from the compressor.

9. The diaphragm valve assembly of claim 1, further comprising:
a gasket positioned between a bottom surface of the bonnet and a top surface of the body portion, wherein the gasket provides a secondary seal when loaded by pressure applied from the clamp assembly.

10. A diaphragm valve assembly comprising:
a body portion having an inner wall, a first port defined by a first portion of the inner wall, a second port defined by a second portion of the inner wall, and a controllable flow path defined by a third portion of the inner wall between the first port and the second port;
a diaphragm assembly positioned over an opening along the third portion of the inner wall, the diaphragm assembly configured to provide a peripheral seal along a periphery of the opening and a passage seal along a diametric weir within the opening;
a bonnet to house an assembly comprising a pressure ring, a compressor, and a spindle to actuate a position of the compressor between a closed position and an open position such that the diaphragm assembly forms the passage seal in the closed position or releases the passage seal in the open position;
an actuator to actuate a position of the spindle between the open position and the closed position;
an adapter to fit over the body portion; and
a clamp assembly to affix the adapter and the bonnet together through application of substantially even pressure by an inside surface of the clamp assembly.

11. The diaphragm valve assembly of claim 10, wherein the adapter is to provide backward compatibility to an existing valve.

12. The diaphragm valve assembly of claim 10, wherein the actuator is one of a manual actuator, an electrical actuator, and a pneumatic actuator.

13. The diaphragm valve assembly of claim 10, wherein the clamp assembly comprises two or more clamp portions, one or more hinges, and a safety mechanism.

14. The diaphragm valve assembly of claim 13, wherein the safety mechanism comprises a nut-bolt employing a wing nut a hex nut, or a safety nut.

15. The diaphragm valve assembly of claim 13, wherein an inside surface of the two or more clamp portions includes an angled top portion and an angled bottom portion to slidably mate with matching angled outside surfaces of the bonnet and the adapter.

16. The diaphragm valve assembly of claim 10, further comprising:
a gasket positioned between a bottom surface of the bonnet and a top surface of the adapter, wherein the gasket provides a secondary seal when loaded by pressure applied from the clamp assembly.

17. The diaphragm valve assembly of claim 10, wherein the adapter is affixed to the body portion through pressure studs or threaded bolts.

18. The diaphragm valve assembly of claim 10, wherein a centering mechanism by a portion of the bonnet engaged with the body portion keeps the bonnet and body portion aligned during actuation.

19. The diaphragm valve assembly of claim 10, wherein a weir and a bead alignment is facilitated through one of diaphragm and cushion fold-over tabs and diaphragm and cushion extended tabs.

20. A method of manufacturing a diaphragm valve assembly comprising:
forming a body portion having an inner wall, a first port defined by a first portion of the inner wall, a second port defined by a second portion of the inner wall, and a controllable flow path defined by a third portion of the inner wall between the first port and the second port;
positioning a diaphragm assembly over an opening along the third portion of the inner wall to provide a peripheral seal along a periphery of the opening and a passage seal along a diametric weir within the opening;
coupling a bonnet to the body portion through a clamp assembly to affix the body portion and the bonnet together through application of substantially even pressure by an inside surface of the clamp assembly, wherein the bonnet houses an assembly comprising a pressure ring, a compressor, and a spindle to actuate a position of the compressor between a closed position and an open position such that the diaphragm assembly forms the passage seal in the closed position or releases the passage seal in the open position; and
coupling an actuator to the bonnet to actuate a position of the spindle between the open position and the closed position, wherein the actuator is one of a manual actuator, an electrical actuator, and a pneumatic actuator.
